(19) United States
(12) Patent Application Publication
(10) Pub. No.: US 2013/0167054 A1
(43) Pub. Date: Jun. 27, 2013

(54) DISPLAY APPARATUS FOR RELEASING LOCKED STATE AND METHOD THEREOF

(71) Applicants: Ji-yeon KWAK, Seoul (KR); Jung-joo SOHN, Seoul (KR); Nipun KUMAR, Suwon-si (KR)

(72) Inventors: Ji-yeon KWAK, Seoul (KR); Jung-joo SOHN, Seoul (KR); Nipun KUMAR, Suwon-si (KR)

(73) Assignee: Samsung Electronics Co., Ltd., Suwon-si (KR)

(21) Appl. No.: 13/590,753

(22) Filed: Aug. 21, 2012

(30) Foreign Application Priority Data
Dec. 23, 2011 (KR) 10-2011-0141805

(51) Int. Cl. G06F 3/048

(52) U.S. Cl. 715/764

(57) ABSTRACT

A method and apparatus are provided for releasing a locked state. A display unit displays a locked view including a plurality of affordance objects. When a user touches the display unit in a direction of the affordance objects in the locked view, a control unit controls the display unit to switch to an unlocked view while dispersing the affordance objects.

### PRIORITY

This application claims priority under 35 U.S.C. §119(a) to Korean Patent Application No. 2011-0141805, filed on Dec. 23, 2011 in the Korean Intellectual Property Office, the entire disclosure of which is incorporated herein by reference.

### BACKGROUND OF THE INVENTION

1. Field of the Invention

The present invention relates generally to a display apparatus, and more particularly, to a display apparatus for releasing a locked state using an affordance object displayed in a locked view, and a method for releasing the locked state.

2. Description of the Related Art

Various display devices have been developed in accordance with the advances in electronic technology. Recently, the use of display devices, such as, for example, smart phones or tablet Personal Computers (PCs), which support various applications, is rapidly increasing.

A display device may include a large touch screen, which allows a user to more easily control the manipulation of the display device while viewing contents. However, when using the large touch screen, the screen of the display device may be touched to execute a function even when it is not the user's intention.

To avoid this, the display device can include a locking function. When the screen is touched or a key is selected while in a locked state, no function is performed. The user can release the locked state with a preset manipulation.

The user manipulation for releasing the locked state can be defined by a display device manufacturer. For example, the manufacturer can design to release the locked state only through a predefined manipulation within a fixed part on the screen.

However, when the fixed manipulation is continuously performed in the fixed part of the screen, pixels of the corresponding part or touch sensors under the screen are repeatedly used, thereby degrading the sensing performance.

Further, the fixed or predefined manipulation does not meet user's needs for a more dynamic and interesting User Interface (UI).

### SUMMARY OF THE INVENTION

The present invention has been made to address at least the above problems and/or disadvantages and to provide at least the advantages described below. Accordingly, an aspect of the present invention provides a display apparatus that allows a user to easily and intuitively release a locked state using an affordance object, and a method for releasing the locked state.

According to an aspect of the present invention, a display apparatus is provided that includes a display unit for displaying a locked view including a plurality of affordance objects. The display apparatus also includes a control unit for, when a user touches the display unit in a direction of the affordance objects in the locked view, controlling the display unit to switch to an unlocked view while dispersing the affordance objects.

According to another aspect of the present invention, a method is provided for releasing a locked state of a display apparatus. A locked view including a plurality of affordance objects is displayed on a display unit. When a user touches the display unit in a direction of the affordance objects in the locked view, an unlocked view is switched to while dispersing the affordance objects.

### BRIEF DESCRIPTION OF THE DRAWINGS

The above and other aspects, features and advantages of the present invention will be more apparent from the following description when taken in conjunction with the accompanying drawings, in which:

FIG. 1 is a block diagram illustrating a display apparatus, according to an embodiment of the present invention;

FIGS. 2 through 6 are diagrams illustrating various unlocking methods in the display apparatus, according to embodiments of the present invention;

FIG. 7 is a block diagram illustrating a display apparatus, according to another embodiment of the present invention;

FIGS. 8 through 11 are diagrams illustrating affordance object display change when a call connection request is received, according to an embodiment of the present invention;

FIGS. 12 through 16 are diagrams illustrating various user manipulations, according to embodiments of the present invention;

FIG. 17 is a flowchart illustrating an unlocking method, according to an embodiment of the present invention; and

FIG. 18 is a flowchart illustrating an unlocking method, according to another embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

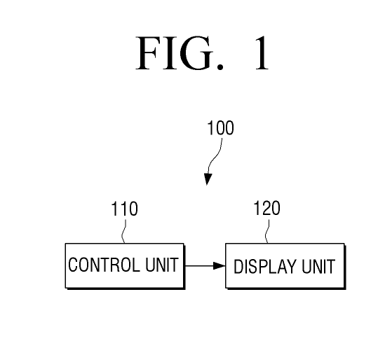

FIG. 1 is a block diagram illustrating a display apparatus, according to an embodiment of the present invention. Referring to FIG. 1, a display apparatus 100 includes a control unit 110 and a display unit 120.

The control unit 110 controls operations of the display apparatus 100. The control unit 110 can control hardware of the display apparatus 100 and support various functions by executing an Operating System (OS) or various applications stored to a memory of the display apparatus 100.

When the display apparatus 100 is turned on or reset, when the ongoing function of the display apparatus 100 is completed, or when there is no user manipulation or operation of the display apparatus 100 during a certain time, the control unit 110 operates in a locked state. When an event, such as user screen touch or button selection in the display apparatus 100, occurs while in the locked state, the control unit 110 controls the display unit 120 to display a locked view.

The display unit 120 displays the locked view including a plurality of affordance objects. An affordance object is an object generated to induce the user manipulation. Specifically, the plurality of the affordance objects can be images of various types converged and displayed on a certain point of the locked view.

When the user touches the point of the converged affordance objects in the locked view, the control unit 110 controls the display unit 120 to scatter the plurality of the affordance objects and to switch to an unlocked view. The affordance objects can disperse as moving away from the touch trace of the user.

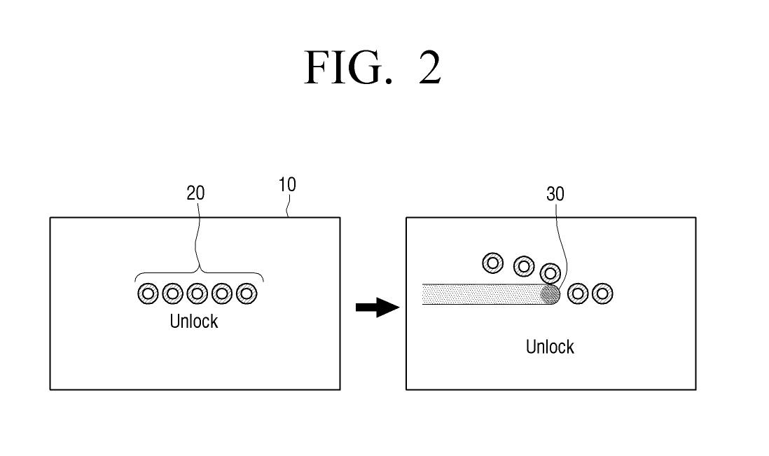

FIG. 2 illustrates affordance objects, according to an embodiment of the present invention. Referring to FIG. 2, a plurality of affordance objects 20 is displayed in a locked view 10. In FIG. 2, the affordance objects 20 are arranged along a line. When the user drags toward the affordance objects 20, each affordance object 20 moves away from a drag trace 30. Specifically, the display apparatus 100 displays that the affordance objects 20 are pushed by the user, and switches to the unlocked view.

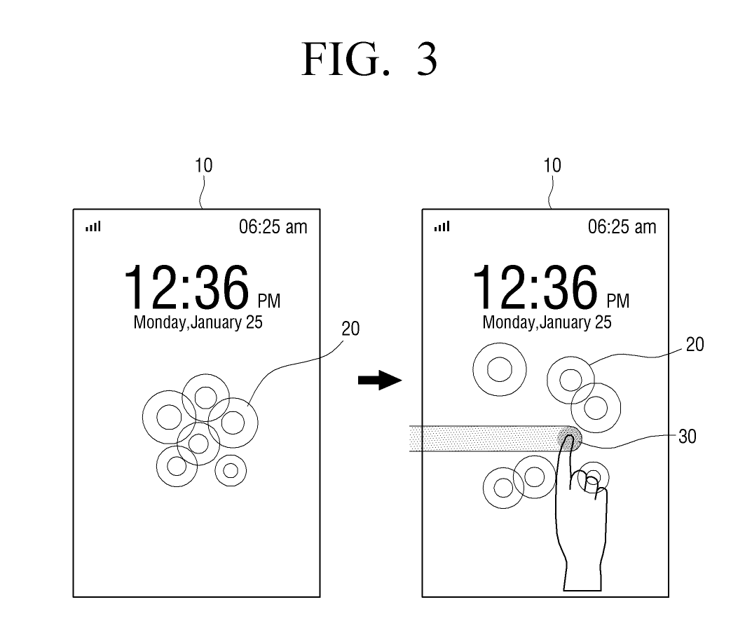

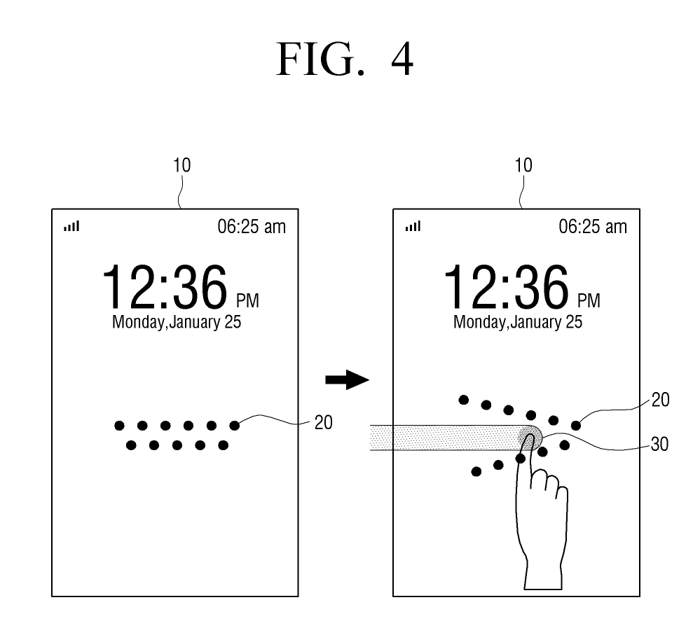

FIGS. 3 and 4 illustrate other affordance objects, according to embodiments of the present invention.

Referring to FIG. 3, the plurality of affordance objects 20 is irregularly gathered around a point in the locked view 10. When the user drags toward the gathered affordance objects 20, the control unit 110 controls the display unit 120 to disperse the affordance objects 20 to avoid the contact of the touch trace 30.

Referring to FIG. 4, the plurality of affordance objects 20 is arranged and displayed in two lines. When the user drags a touch between the two lines, the control unit 110 controls the display unit 120 to split the affordance objects 20 while avoiding the touch trace 30.

The user touches the ends of the line of affordance objects in FIGS. 2, 3 and 4, but the embodiments of the present invention are not limited thereto. For example, when the user rubs or taps a middle point of the line of affordance objects, the affordance objects 20 can disperse based on this point.

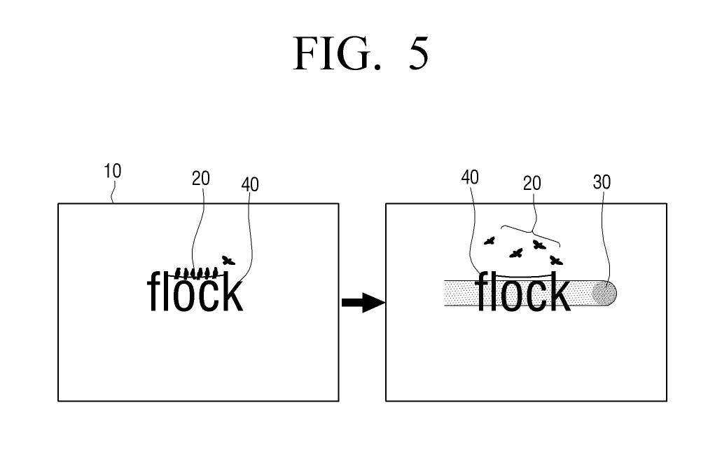

FIG. 5 illustrates another affordance object, according to an embodiment of the present invention. Referring to FIG. 5, the locked view 10 displays a fixed object 40. A plurality of life images 20 is displayed as the affordance object on the fixed object 40. The life images 20 are gathered and displayed on the fixed object 40.

When the user drags a touch toward the fixed object 40, the control unit 110 controls the display unit 120 to maintain the fixed object 40 and to disperse the life images 20 away from the touch trace 30. For example, the control unit 110 controls the display unit 120 to display birds flying away with the user's touch. Accordingly, the user can find enjoyment even in the lock release. While the life images 20, such as birds, are depicted in FIG. 5, other animal or plant images can be applied.

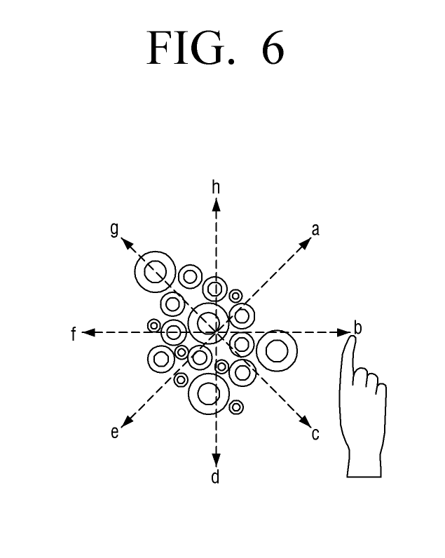

FIG. 6 depicts a drag direction of the user with respect to a plurality of affordance objects, according to an embodiment of the present invention. Referring to FIG. 6, the user can release the lock by dragging in various directions, a through h, with respect to the convergence point of the plurality of the affordance objects. The touch trace can vary in form, such as, for example, a straight line or a curve.

While the affordance object changes when the user applies the dragging operation in the above embodiments of the present invention, the user's touch operation can vary. For example, the user's touch operation can be embodied as dragging, rubbing, long pressing, flicking, and tapping.

Besides the affordance object 20, the locked view 10 can display basic information such as a time, a date, and weather. The basic information can be displayed at locations in the locked view 10 that do not to overlap with the affordance objects.

The unlocked view, which is displayed after the affordance object is changed, can vary according to embodiments of the present invention. For example, the unlocked view can be an execution view generated according to the execution of a particular application. Specifically, when the lock is released, the execution view of an application used before the display apparatus enters the locked state, a default application, or an application frequently used can be displayed immediately. When the line connected with one affordance object is cut as shown in FIG. 5, the execution view of the function corresponding to the affordance object may be used as the unlocked view.

For example, the unlocked view may include an icon display region, which arranges applications installed on the display apparatus, widgets, folder icons, and menus, and a fixed menu region. The fixed menu region displays menus of functions frequently used by the user, such as call, message, Internet, recent call list, or default functions.

As described above, the unlocked view can be automatically displayed after the affordance objects are dispersed.

Also, as described above, the affordance objects include a variety of objects displayable to disperse away from the user's touch. The affordance objects can induce the user's touch by itself However, a text or an indicator image instructing to touch the affordance object may be displayed beside of the affordance objects so that the user can more clearly understand that the affordance objects need to be touched to release the lock. Alternatively, the affordance objects may regularly wave or flicker so that the user can intuitively recognize the touch.

The display apparatus can be implemented using various devices including a TV, a table PC, a PC, a notebook PC, a digital frame, an e-book, a PDA, and a mobile phone. A display apparatus having the communication capability, such as mobile phone, can receive a call in the locked state. In this case, the affordance objects can be changed to determine whether to receive or reject the call in the locked view.

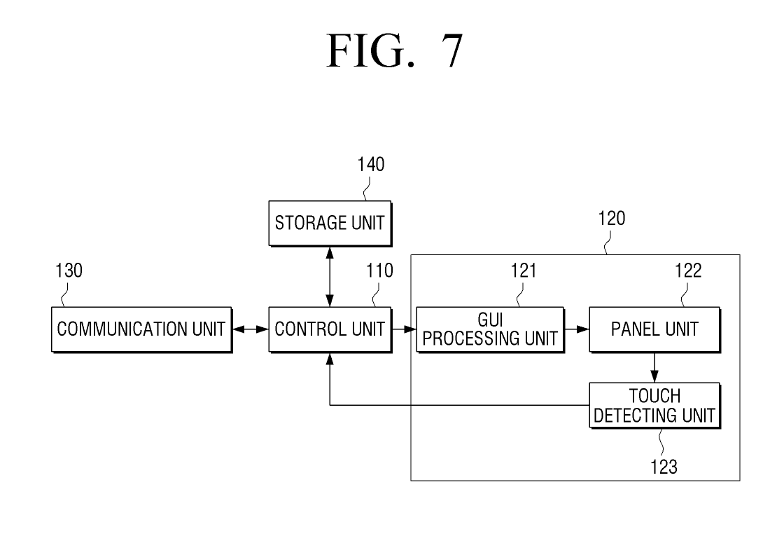

FIG. 7 is a block diagram illustrating a display apparatus, according to another embodiment of the present invention. Referring to FIG. 7, the display apparatus includes the control unit 110, the display unit 120, a communication unit 130, and a storage unit 140.

The display unit 120 includes a Graphical User Interface (GUI) processing unit 121, a panel unit 122, and a touch detection unit 123. Using setup information stored to the storage unit 140, the GUI processing unit 121 generates screen configuration data of various types, such as the locked view, the unlocked view, and an application execution view. Based on the screen configuration data generated by the GUI processing unit 121, the panel unit 122 displays the view by driving hardware including a Liquid Crystal Display (LCD) display panel and a backlight unit. The touch detection unit 123 provides coordinates of the user's touch point to the control unit 110, using a touch sensor equipped in the panel unit 122.

The control unit 110 controls the GUI processing unit 121 and the panel unit 122 to output the view corresponding to the current state of the display apparatus. Using the coordinates provided from the touch detection unit 123, the control unit 110 calculates the user's touch point, touch trace, and movement speed. Based on the calculation results, the control unit 110 determines dispersion characteristics of the affordance object. For example, when the touch operation of the user is a dragging motion, the control unit 110 can regulate a dispersion speed, a dispersion direction, and a dispersion degree of the affordance objects according to the speed, direction, and distance of the user drag. Specifically, the dispersion speed is high for a fast dragging motion and is low for a slow dragging motion. The dispersion direction can be defined to be pushed away from the user's touch in association with the drag direction. The dispersion degree, that is, the distance of the dispersion and the movement can vary according to the drag distance.

The storage unit 140 stores the O/S, applications, a widget program, and data. In particular, the storage unit 140 can store information relating to at least one of various affordance objects.

The control unit 110 can be driven by the O/S stored to the storage unit 140 to execute various applications or widget programs selected by the user and to carry out the function. When it is necessary to switch to the locked state, the control unit 110 enters the locked state so that the display apparatus does not respond to any key manipulation or touch of the user. When the user arbitrarily manipulates the key or touches the screen in the locked state, the control unit 110 controls the display unit 120 to generate and display the locked view.

The communication unit 130 receives a call connection request over a telephone network. When the call is connected, the communication unit 130 converts the user's input voice to a voice signal, transmits the voice signal to the other telephone over the telephone network, converts a voice signal received from the other telephone, and provides the voice signal to a speaker.

When the affordance object is touched in the locked view, the control unit 110 controls the display unit 120 to display that the line is cut based on the touch point and direction and the affordance object is dispersed, and to display the unlocked view.

As such, when the storage unit 140 stores various affordance objects, the control unit 110 may randomly determine the affordance object displayed in the locked view. Naturally, the affordance object displayed in the locked view can vary at random.

In the locked state with the locked view displayed, when the call connection request is received through the communication unit 130, the control unit 110 can modify the form or number of the affordance objects so that the user can select whether to connect or reject the call.

When the call connection request is received through the communication unit 130, even in the unlocked state, the control unit 110 can control the display unit 120 to display the affordance objects so that the user can select whether to connect to or reject the call.

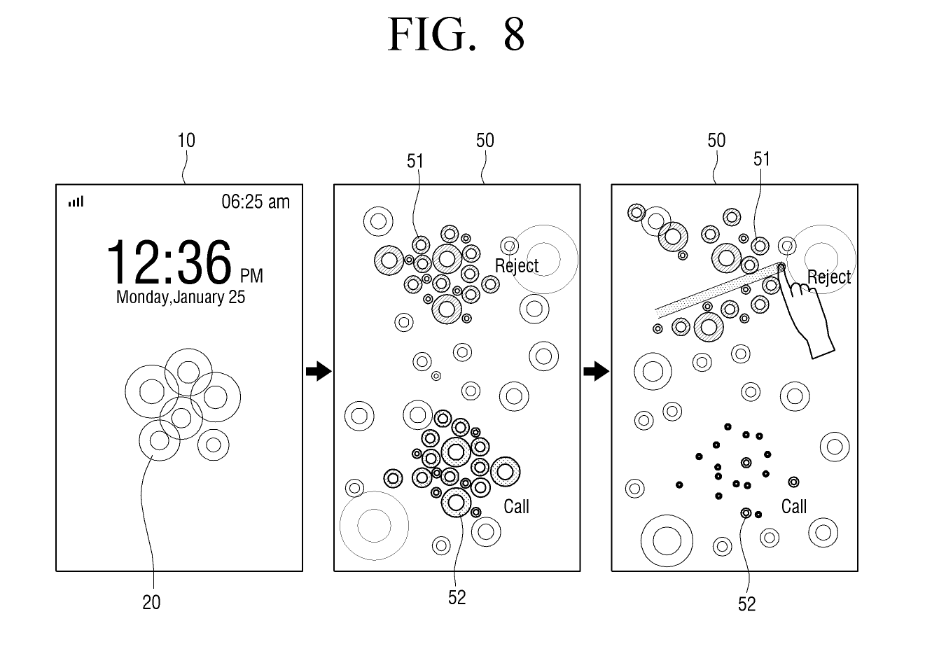

FIG. 8 illustrates the change of the locked view when the call connection request is received, according to an embodiment of the present invention. Referring to FIG. 8, when the call connection request is received while the locked view 10 including the affordance objects 20 of FIG. 3 are displayed, a call reception view 50 including first and second affordance object groups 51 and 52 are displayed.

The first affordance object group 51 is mapped to the call rejection function, and the second affordance object group 52 is mapped to the call connection function. The user can execute his/her intended function by touching one of the two affordance object groups 51 and 52. In FIG. 8, the user drags through the first affordance object group 51, the first affordance object group 51 is dispersed, and thus, the call is rejected. When the user drag scatters the first affordance object group 51, the second affordance object group 52 disappears and the call is rejected.

Meanwhile, when the second affordance object group 52 is selected and the call is connected, the control unit 110 can control the communication unit 130 to connect the call and control the display unit 120 to display a call connection view.

The first affordance object group 51 and the second affordance object group 52 can be displayed and distinguished in different colors, shapes, and sizes. The function mapped to each group can be displayed as a text or an image beside the group.

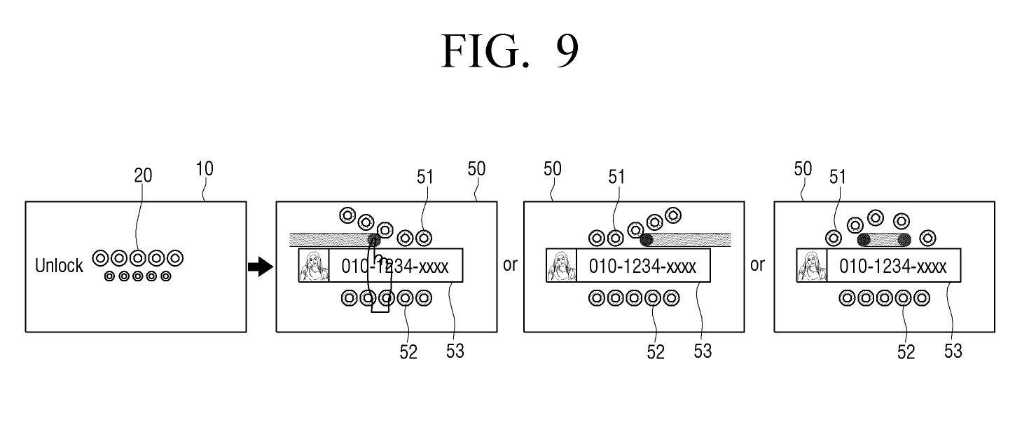

FIG. 9 depicts another change of the locked view when the call connection request is received, according to an embodiment of the present invention. Referring to FIG. 9, the locked view 10 displays a plurality of affordance objects 20 arranged in two lines. When the call connection request is received, a call reception view 50 including a caller information region 53 and first and second affordance object groups 51 and 52 are displayed.

The caller information region 53 displays information such as an image, a name, or a phone number of the caller. Using a caller number of the call connection request received at the communication unit 130, the control unit 110 can read various caller information stored to the storage unit 140. The read caller information is provided to the GUI processing unit 121 of the display unit 120. The GUI processing unit 121 generates data of the phone reception view 50 including the caller information region 53 using the caller information. The generated data is provided to the panel unit 122 to display the call reception view 50.

In FIG. 9, the caller information region 53 is displayed at the center of the call reception view 50, the first affordance object group 51 is displayed above the caller information region 53, and the second affordance object group 52 is displayed below the caller information region 53. The user can select the call connection or the call rejection by scattering the first or second affordance object group, 51 or 52, in various fashions. In FIG. 9, the user can perform drag touch through the first affordance object group 51 from left to right or from right to left, or touch and rub from the center to left and right.

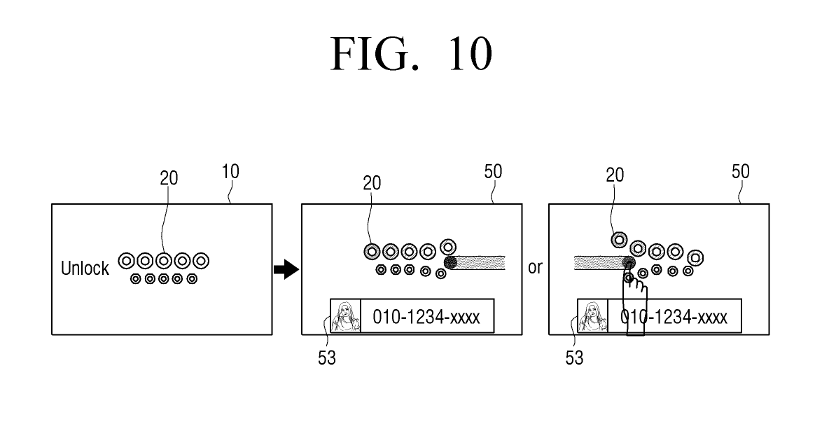

FIG. 10 illustrates another change of the locked view when the call connection request is received, according to an embodiment of the present invention. Referring to FIG. 10, the call reception view 50 includes the call information region 53 and the affordance objects 20. The affordance objects 20, which are displayed in the call reception view 50, differ in color from the affordance objects 20 displayed in the locked view 10. The user can disperse the affordance objects 20 by performing a dragging touch through the affordance object 20 in various directions, for example, to the right or to the left.

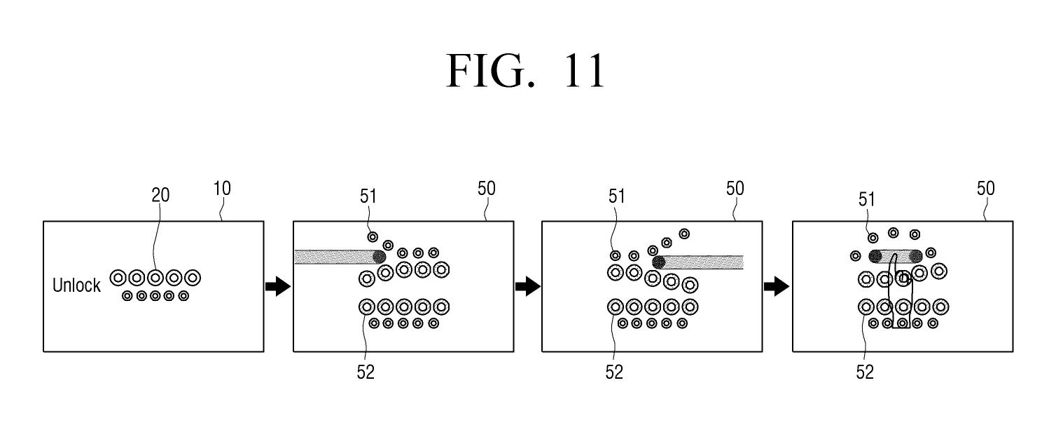

FIG. 11 illustrates another change of the locked view when the call connection request is received, according to an embodiment of the present invention. Referring to FIG. 11, the first affordance object group 51 and the second affordance object group 52 are each arranged in two lines and displayed at different locations. The user can perform a drag touch between the lines of the groups 51 and 52 from left to right or from right to left, or touch between the lines and rub horizontally. Hence, the affordance object group 51 is dispersed and the corresponding function is conducted. Specifically, when the call connection is selected, the call connection view is displayed.

The mapping of the call connection function to the affordance object can vary depending on the design.

While the affordance objects having a same shape as in FIG. 4 but a different color and size is used as the first and second affordance object groups in FIGS. 9, 10 and 11, the first and second affordance object groups can use an image different from the affordance object 20 displayed in the locked view 10.

Specifically, after the affordance object of FIG. 2 is displayed, the plurality of the affordance objects of one of FIGS. 3, 4 and 5 may be displayed, or different affordance objects on the function basis may be displayed. For example, the call connection function can be mapped to the affordance object of FIG. 2 and the call rejection function can be mapped to the affordance object of FIG. 3.

The call connection request can also be received during a non locked state. In this case, the control unit 110 can control the display unit 120 to display the plurality of the affordance objects as described above, map the call connection function or the call rejection function to each affordance object, and conduct the corresponding function in response to the touch.

There can be various operation modes in addition to the received call connection request, such as, for example, a mode for checking a text message or received mail, a power-save mode due to the lack of the remaining battery capacity, and a mode for outputting an alarm signal when an alarm set time arrives. The control unit 110 can enter various operation modes such as a mail check mode, a power-saving mode, and an alarm output mode.

In such operation modes, the control unit 110 can control the display unit 120 to display a plurality of affordance objects mapped to new functions selectable in the corresponding operation mode. For example, the display unit 120 may display affordance objects mapped to the function for checking the text message or the mail received, together with affordance objects mapped to the function for checking caller information or postponing the text message or mail check.

When the set alarm time arrives and the alarm output mode for outputting the alarm signal is transited, the control unit 110 may display a plurality of affordance objects mapped to various functions, such as, for example, affordance objects mapped to an alarm stop function and affordance objects mapped to a function for resetting the alarm after 5 minutes.

Besides, in the power-save mode, a plurality of affordance objects mapped to a function for returning to the normal mode and a function for maintaining the power-save mode may be displayed. As such, the function of the affordance objects can be set in a number of different ways according to the situation.

The plurality of the affordance objects can be represented the same and the text explaining their mapping function can be displayed together.

According to an embodiment of the present invention, at least one of the shape, the size, and the color of the affordance objects can differ.

The user can immediately select his/her intended function by cutting the affordance objects represented according to various embodiments of the present invention.

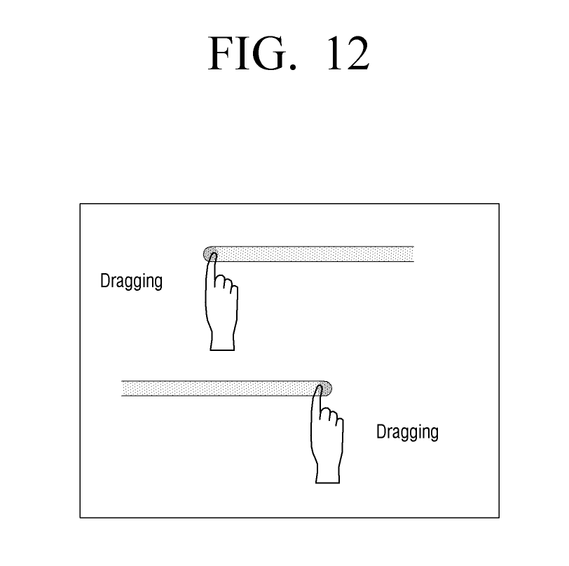

FIGS. 12 through 16 illustrate various user manipulations, according to embodiments of the present invention.

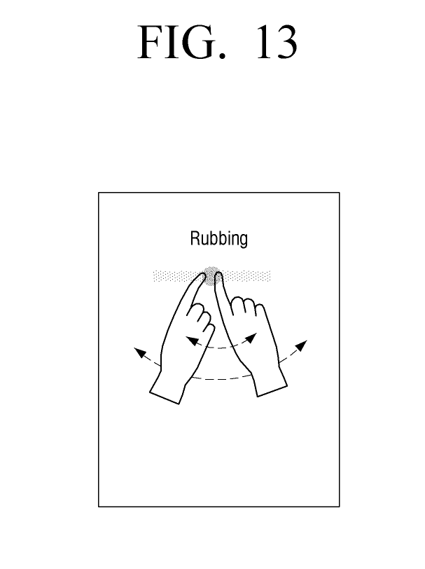

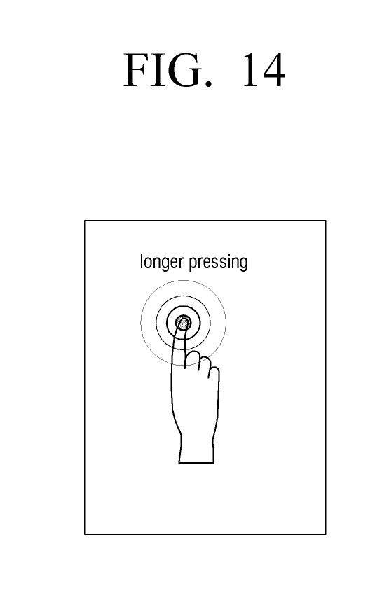

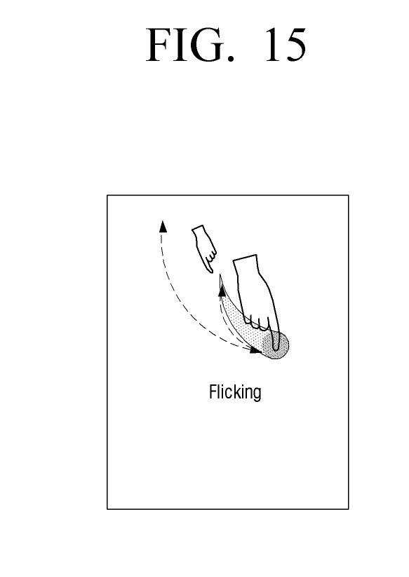

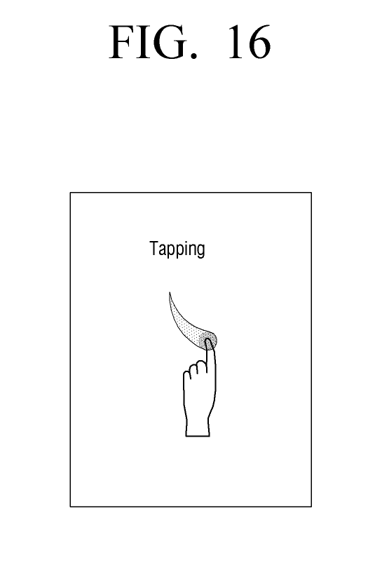

FIG. 12 shows a user drag operation, according to an embodiment of the present invention. The drag is an operation in which a point is touched and the touch is moved to another point while continuously touching. FIG. 13 illustrates a user rubbing operation, according to an embodiment of the present invention. Rubbing is an operation in which a point is touched and the touch moves forward and backward. FIG. 14 illustrates a long pressing operation that presses a point over a threshold time, according to an embodiment of the present invention. FIG. 15 illustrates a flicking operation in which a point is touched and the touch suddenly moves to one direction, according to an embodiment of the present invention. FIG. 16 illustrates a tapping operation in which a fingertip softly touches, according to an embodiment of the present invention. As such, the user can touch and control the screen in various manners. Specifically, when the user drags or flicks, the affordance objects can change to avoid the touch trace. When the user rubs, presses long, or taps the gathered affordance objects, the affordance objects can disperse in response.

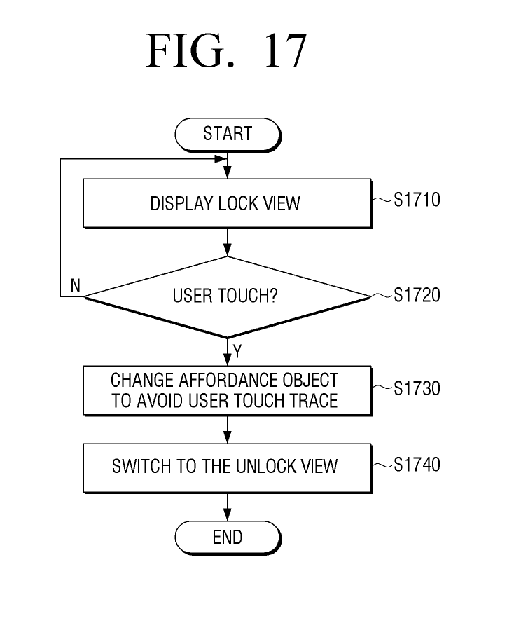

FIG. 17 is a flowchart illustrating an unlocking method, according to an embodiment of the present invention. Referring to FIG. 17, the display apparatus displays the locked view including the affordance objects in the locked state, in step S1710. The affordance objects can include a plurality of affordance objects gathered or arranged, or a life image gathered at a fixed object. Specifically, the affordance objects can be generated in various forms as shown in FIGS. 2 through 5.

The user can touch the affordance objects on the screen using a finger or a touch pen, in step S1720. In response to the touch, the affordance objects are pushed and dispersed to avoid the touch trace, in step S1730.

As the affordance object is changed, the unlocked view is displayed, in step S1740. The unlocked view can be realized in various forms as aforementioned.

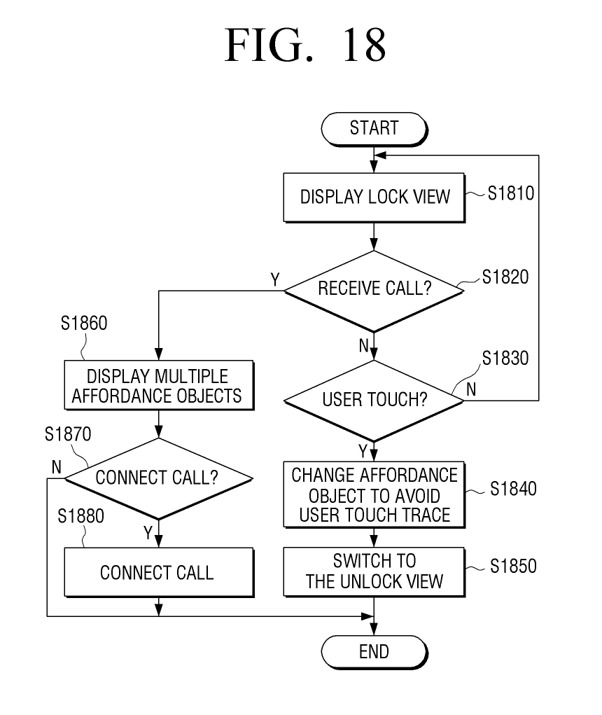

FIG. 18 is a flowchart illustrating an unlocking method, according to another embodiment of the present invention. Referring to FIG. 18, when the locked view is displayed in step S1810 and the call is received in step S1820, the plurality of the affordance objects is displayed in the locked view in step S1860. Each group of affordance objects is mapped to a function. For example, the affordance object group mapped to the call connection function and the affordance object group mapped to the call rejection function can be displayed together. The caller information can be displayed together with the affordance object groups.

The user can determine whether to connect the call by touching the affordance object group mapped to the call connection function or the affordance object group mapped to the call rejection function, in step S1870. When the affordance object group mapped to the call connection is touched, the call is connected in step S1880 and the call connection view is displayed. By contrast, when the other affordance object group is touched, the call connection is rejected.

When the call is not received in step S1820 and the user touches the affordance objects in step S1830, the display apparatus changes the affordance objects to disperse according to the touch trace in step S1840 and switches to the unlocked view by releasing the locked state in step S1850.

While the plurality of the affordance objects is displayed when the call is received in FIG. 18, various operation modes can be provided besides the call reception mode. Every time the display apparatus enters each operation mode, it can further display at least one affordance object mapped to the function of the corresponding operation mode.

When the call is received or the operation mode is changed during the non locked state, a plurality of affordance object groups mapped to the function can be displayed.

The affordance objects displayed in the locked view and the affordance objects displayed when the call is received or other operation mode is switched can be realized in the same or a different form according to embodiments of the present invention.

As such, since the user releases the lock by touching a certain part of the affordance objects, the fixed part is not repeatedly used to release the lock. Since the affordance objects vary based on the random determination, the lock can be released by evenly touching the screen. Thus, partial degradation of the touch panel can be prevented, and the user can find interest in releasing the lock to thus maximize user satisfaction.

A program for executing the unlocking methods according to various embodiments of the present invention can be separately provided and recorded to a recording medium. An apparatus mounted with the recording medium can fulfill the unlocking methods by executing the corresponding program.

In detail, the program for executing the unlocking methods can be contained in various recording media readable by the terminal, such as Random Access Memory (RAM), flash memory, Read Only Memory (ROM), Erasable Programmable ROM (EPROM), Electronically Erasable and Programmable ROM (EEPROM), register, hard disc, removable disc, memory card, USB memory, and CD-ROM.

Although certain embodiments of the present invention have been shown and described, it will be understood by those skilled in the art that various changes may in form and detail may be made therein without departing from the spirit and scope of the invention as defined by the appended claims and their equivalents.

What is claimed is:

1. A display apparatus comprising:
a display unit for displaying a locked view comprising a plurality of affordance objects; and
a control unit for, when a user touches the display unit in a direction of the affordance objects in the locked view, controlling the display unit to switch to an unlocked view while dispersing the affordance objects.

2. The display apparatus of claim 1, wherein the user touches the display unit using a dragging motion, and
the control unit regulates a dispersion speed, a dispersion direction, and a dispersion degree of the affordance objects according to a speed, a direction, and a distance of the dragging motion.

3. The display apparatus of claim 1, further comprising:
a storage unit for storing information on a type of the affordance objects,
wherein the control unit randomly determines and changes the type of the affordance objects in the storage unit every time the locked view is displayed.

4. The display apparatus of claim 1, further comprising:
a communication unit for receiving a call connection request,
wherein, when the call connection request is received, the control unit controls the display unit to display a call reception view comprising a first affordance object group mapped to a call rejection function and a second affordance object group mapped to a call connection function, and the control unit executes the call rejection function or the call connection function corresponding to the first or second affordance object group dispersed when the user touches the display unit in a direction of the first affordance object group or the second affordance object group.

5. The display apparatus of claim 4, wherein the call reception view comprises an information display region that displays caller information.

6. The display apparatus of claim 1, wherein the plurality of the affordance objects is displayed as an irregular gathering based on a point in the locked view, and is dispersed to avoid a touch trace when the user touches the display unit in a direction of the gathered affordance objects.

7. The display apparatus of claim 1, wherein the plurality of the affordance objects is displayed as at least one line arranged in the locked view, and is dispersed to avoid a touch trace when the user touches the display unit in a direction of the arranged affordance objects.

8. The display apparatus of claim 1, wherein the plurality of the affordance objects is a plurality of life images gathered and displayed at a location of a fixed object displayed in the locked view, and
when the user touches the display unit in a direction of the location of the fixed object, the fixed object remains still and the life images are dispersed to avoid contact of a touch trace.

9. A method for releasing a locked state of a display apparatus, the method comprising the steps of
displaying a locked view comprising a plurality of affordance objects on a display unit; and
when a user touches the display unit in a direction toward the affordance objects in the locked view, switching to an unlocked view while dispersing the affordance objects.

10. The method of claim 9, wherein the user touches the display unit using a dragging motion, and
a dispersion speed, a dispersion direction, and a dispersion degree of the affordance objects are regulated according to a speed, a direction, and a distance of the dragging motion.

11. The method of claim 9, wherein a type of the affordance objects is randomly determined and changed every time the locked view is displayed.

12. The method of claim 9, further comprising:
receiving a call connection request;
when the call connection request is received, displaying a call reception view comprising a first affordance object group mapped to a call rejection function and a second affordance object group mapped to a call connection function; and
executing the call rejection function or the call connection function corresponding to the first or second affordance object group dispersed when the user touches the display unit in a direction of the first affordance object group or the second affordance object group.

13. The method of claim 12, wherein the call reception view comprises an information display region that displays caller information.

14. The method of claim 9, wherein the plurality of the affordance objects is displayed as an irregular gathering based on a point in the locked view, and is dispersed to avoid a touch trace when the user touches the display unit in a direction of the gathered affordance objects.

15. The method of claim 9, wherein the plurality of the affordance objects is displayed as at least one line arranged in the locked view, and is dispersed to avoid a touch trace when the user touches the display unit in a direction of the arranged affordance objects.

16. The method of claim 9, wherein the plurality of the affordance objects is a plurality of life images gathered and displayed at a location of a fixed object displayed in the locked view, and
when the user touches the display unit in a direction of the location of the fixed object, the fixed object remains still and the life images are dispersed to avoid contact of a touch trace.
